(19) United States
(12) Patent Application Publication
(10) Pub. No.: US 2014/0091884 A1
(43) Pub. Date: Apr. 3, 2014

(54) Substrate Integrated Waveguide to Air Filled Waveguide Transition

(71) Applicant: Gary Flatters, Durham (GB)

(72) Inventor: Gary Flatters, Durham (GB)

(73) Assignee: FILTRONIC PLC, Shipley, Yorkshire (GB)

(21) Appl. No.: 14/111,892

(22) PCT Filed: Apr. 12, 2012
(86) PCT No.: PCT/GB2012/050798

§ 371 Date: Dec. 5, 2013

(30) Foreign Application Priority Data
Apr. 12, 2011 (GB) 1106160.3

(51) Int. Cl. H01P 1/16; H01P 5/08

(52) U.S. Cl. CPC H01P 5/087
USPC 333/21 R; 333/254; 333/34

(57) ABSTRACT

A substrate integrated waveguide to air filled waveguide transition includes an electrically conductive top layer, an electrically conductive base layer spaced apart from the top layer, wherein the top and base layers each extend along a length axis from a first end to a second end of the transition, the top layer defining a width axis normal to the length axis in the plane of the top layer, and wherein a separation between the top layer and base layer increases towards the second end in a transition region, wherein the transition further includes a dielectric layer sandwiched between the top and base layers, the dielectric layer including a taper portion having a width which tapers to a point at an end point between first and second ends, the width of the taper decreasing towards the second end.

The present invention relates to a substrate integrated waveguide to air filled waveguide transition. More particularly, but not exclusively, the present invention relates to a substrate integrated waveguide to air filled waveguide transition including a dielectric layer, the dielectric layer having a taper portion with a with a width which tapers to a point.

Transitions between substrate integrated waveguides and air filled waveguides are known. CN200965910Y discloses such a transition. The transition disclosed in this earlier document comprises a substrate integrated waveguide portion having a dielectric layer sandwiched between electrically conductive top and bottom layers. It also comprises an air filled waveguide portion comprising electrically conducting connectors which between them define an air filled waveguide. The dielectric layer ends abruptly at the transition between the two portions. Such known transitions suffer from a large degree of insertion loss.

Accordingly, the present invention provides a substrate integrated waveguide to air filled waveguide transition comprising
an electrically conductive top layer;
an electrically conductive base layer spaced apart from the top layer;
the top and base layers each extending along a length axis from a first end to a second end of the transition; the top layer defining a width axis normal to the length axis in the plane of the top layer;
the separation between the top layer and base layer increasing towards the second end in a transition region;
characterised in that
the transition further comprises a dielectric layer sandwiched between the top and base layers, the dielectric layer comprising a taper portion having a width which tapers to a point at an end point between first and second ends, the width of the taper decreasing towards the second end.

The transition region can be arranged between the end point and second end.

Preferably, the top layer is planar.

The separation between the top and base layers in the transition region can increase in a series of steps.

Preferably, the dielectric layer is sandwiched between the top layer and base layer in a region of uniform base layer and top layer separation.

The width of the taper can decrease uniformly with length towards the end point.

Alternatively, the width of the taper can decrease non-uniformly with length towards the end point.

The tip of the taper can be rounded.

Alternatively, the tip of the taper can be a sharp point.

The dielectric layer can comprise a portion of uniform width, the taper portion extending from the region of uniform width towards the second end.

The substrate integrated waveguide to air filled waveguide transition according to the invention can further comprise an air filled waveguide connected to the second end, preferably integrally extending from the second end.

The substrate integrated waveguide to air filled waveguide transition according to the invention can further comprise a substrate integrated waveguide connected to the first end, preferably integrally extending from the first end.

The substrate integrated waveguide to air filled waveguide transition according to the invention can further comprise a signal source connected to the transition and adapted to provide an electromagnetic signal thereto, preferably an E band electromagnetic signal thereto.

Preferably, the length of the taper can be in the range 0.5 λg to 5 λg, where λg is the guide wavelength of the electromagnetic signal propagating through the transition.

More preferably, the length of the taper can be in the range 0.5 λg to 2 λg, more preferably 0.8 λg to 1.5 λg.

Preferably, a portion of at least one of the top layer and base layer adjacent to the taper portion of the dielectric increases in width towards the second end.

The present invention will now be described by way of example only and not in any limitative sense with reference to the accompanying drawings in which

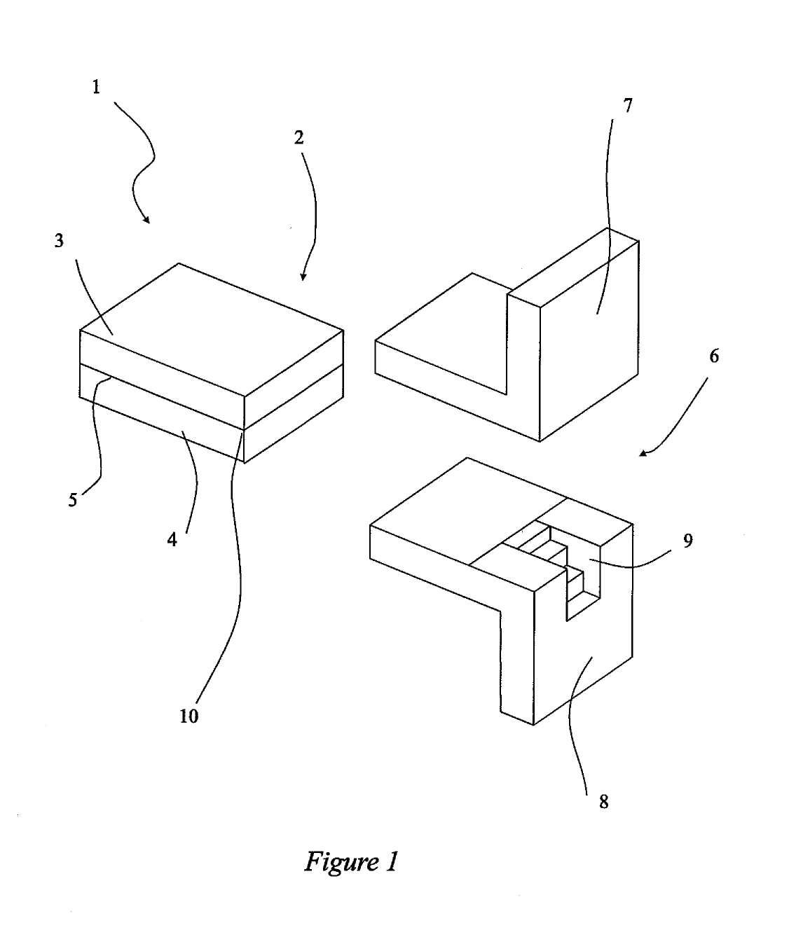

FIG. 1 shows a known substrate integrated waveguide to air filled waveguide transition in perspective view;

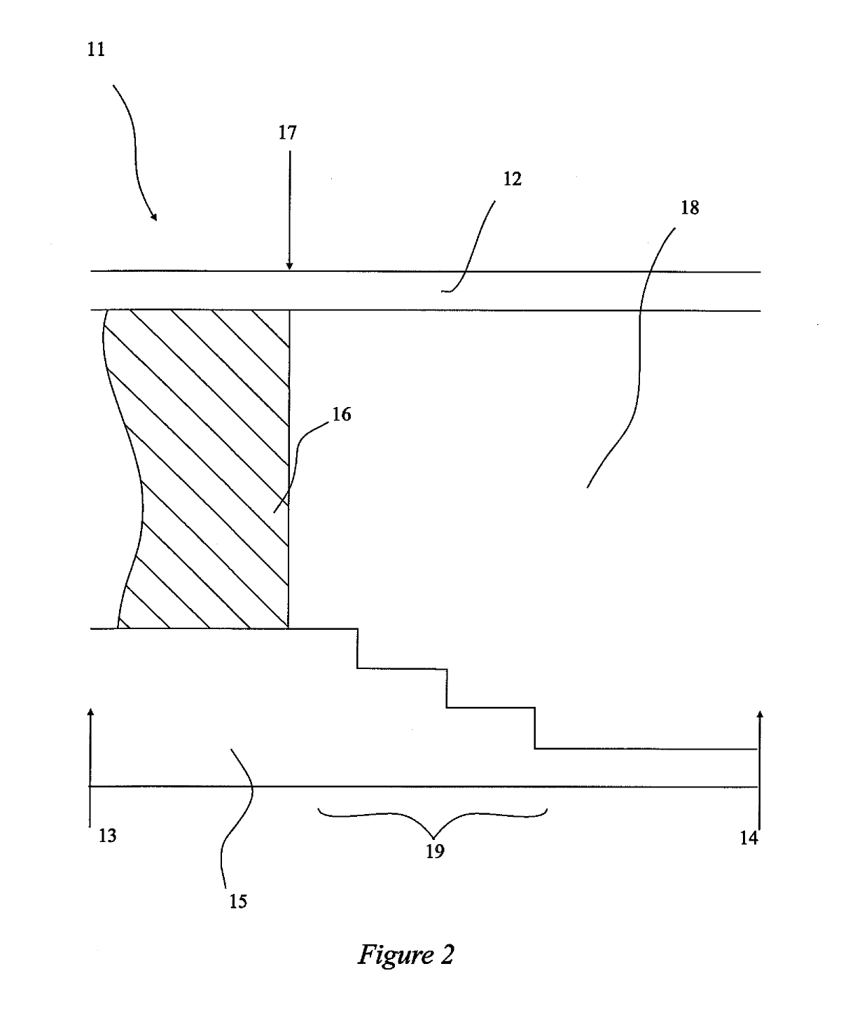

FIG. 2 shows a substrate integrated waveguide to air filled waveguide according to the invention in vertical cross section;

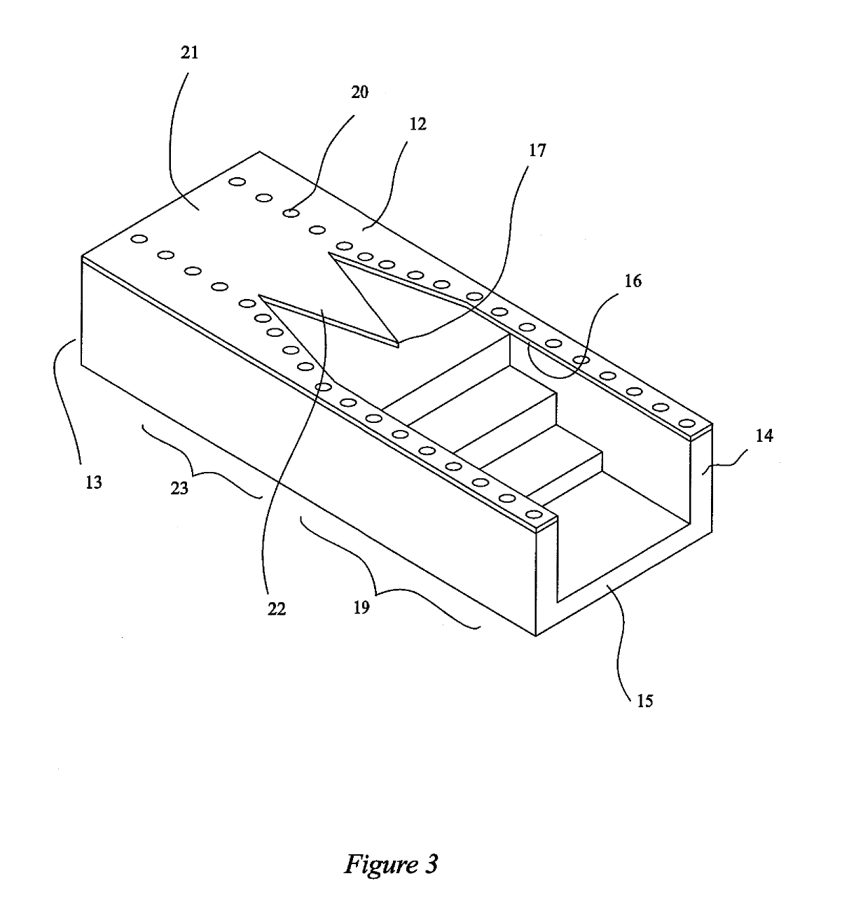

FIG. 3 shows the substrate integrated waveguide to air filled waveguide of FIG. 2 in cut away perspective view;

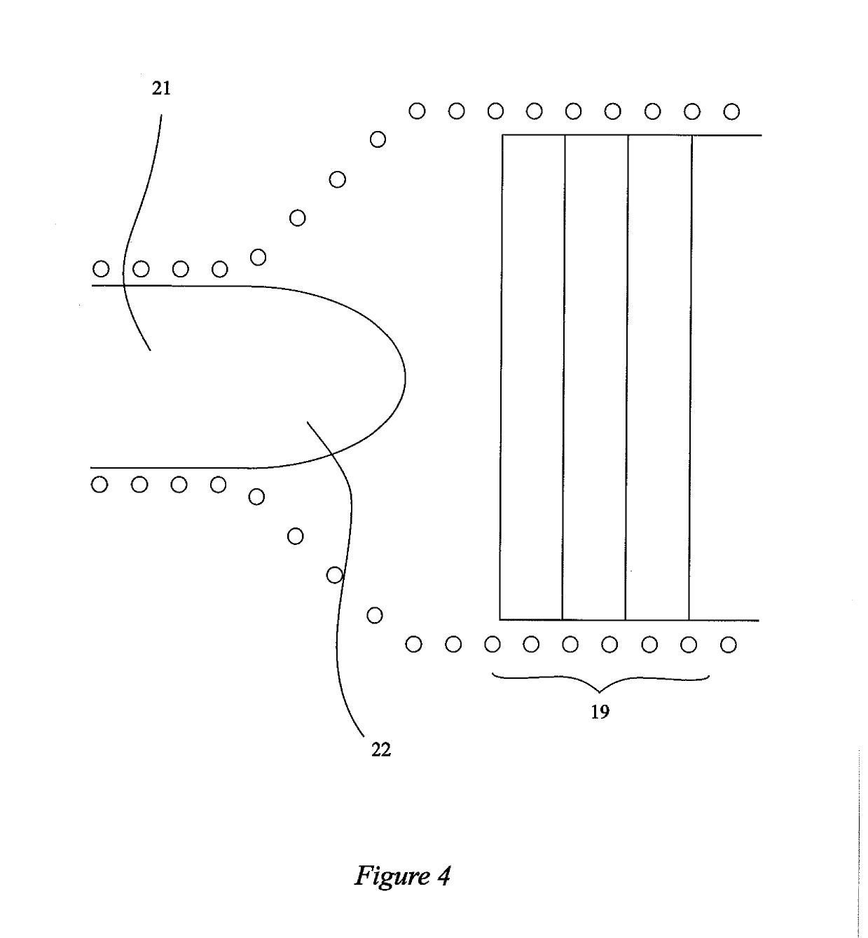

FIG. 4 shows an alternative embodiment of a substrate integrated waveguide to air filled waveguide according to the invention from above;

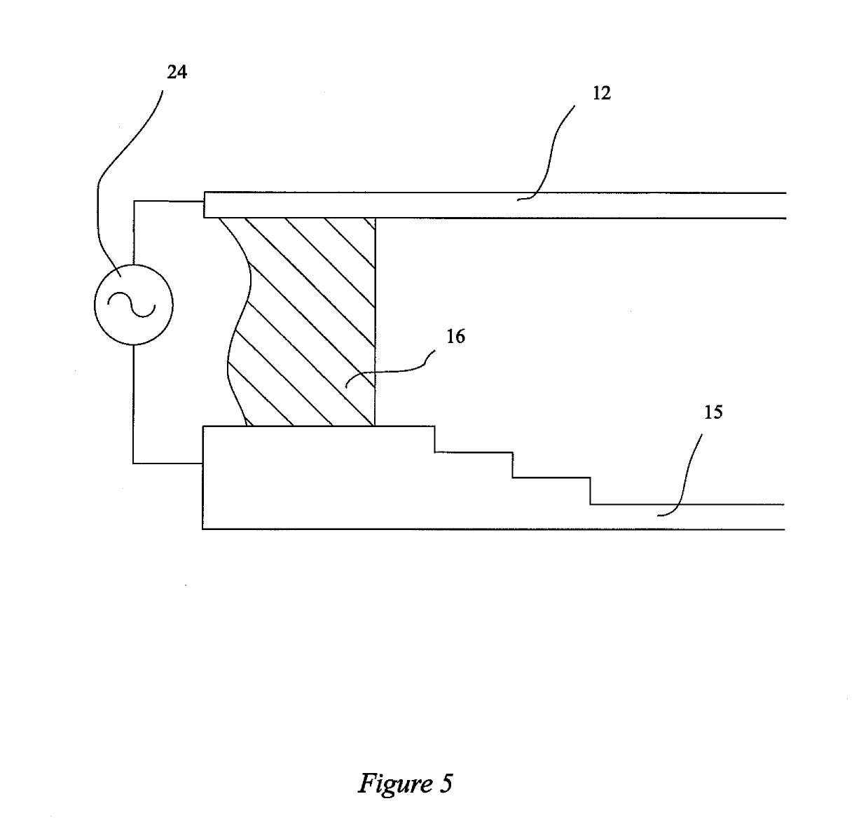

FIG. 5 shows a further embodiment of a substrate integrated waveguide to air filled waveguide according to the invention in vertical cross section;

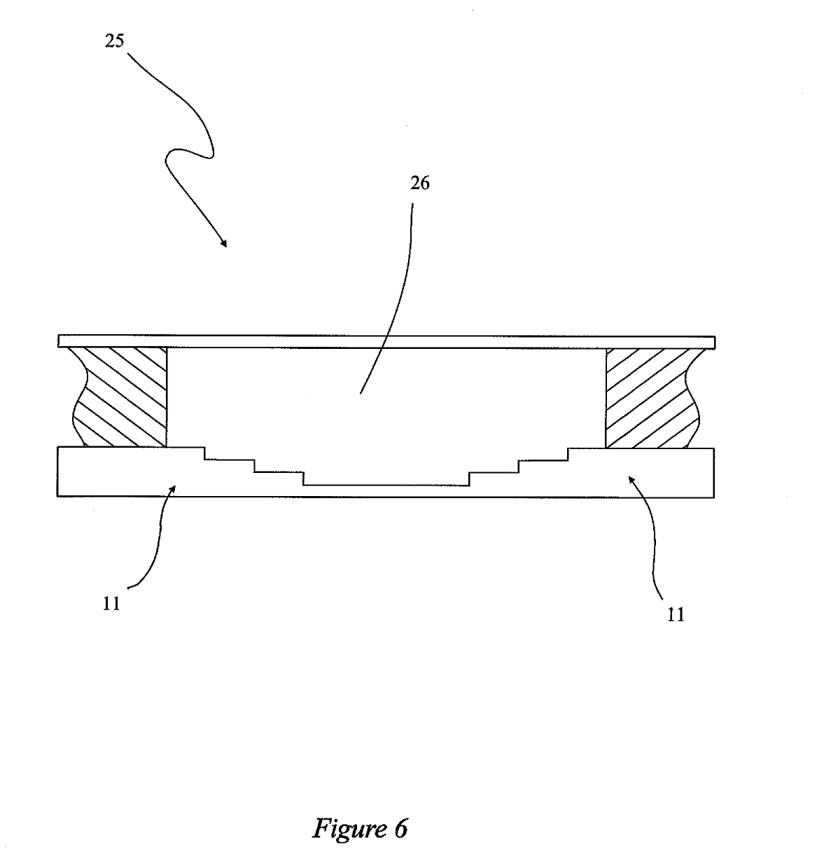

FIG. 6 shows a device including two transitions according to the invention in cross section;

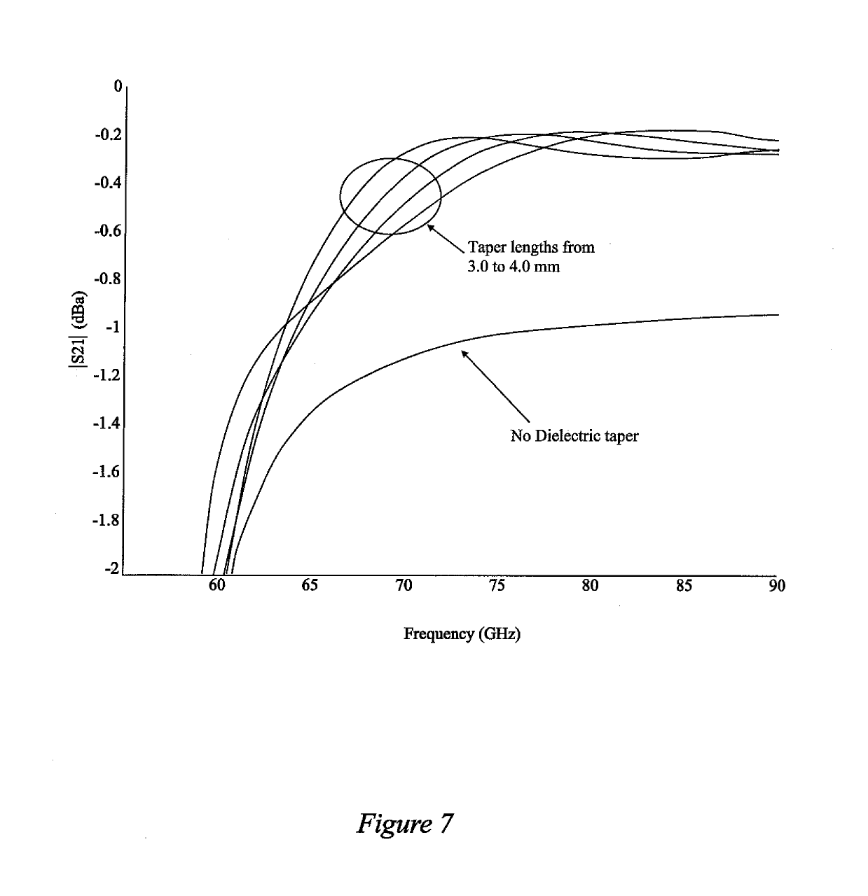

FIG. 7 shows a plot of insertion loss against frequency for transitions including tapers of various lengths and no taper;

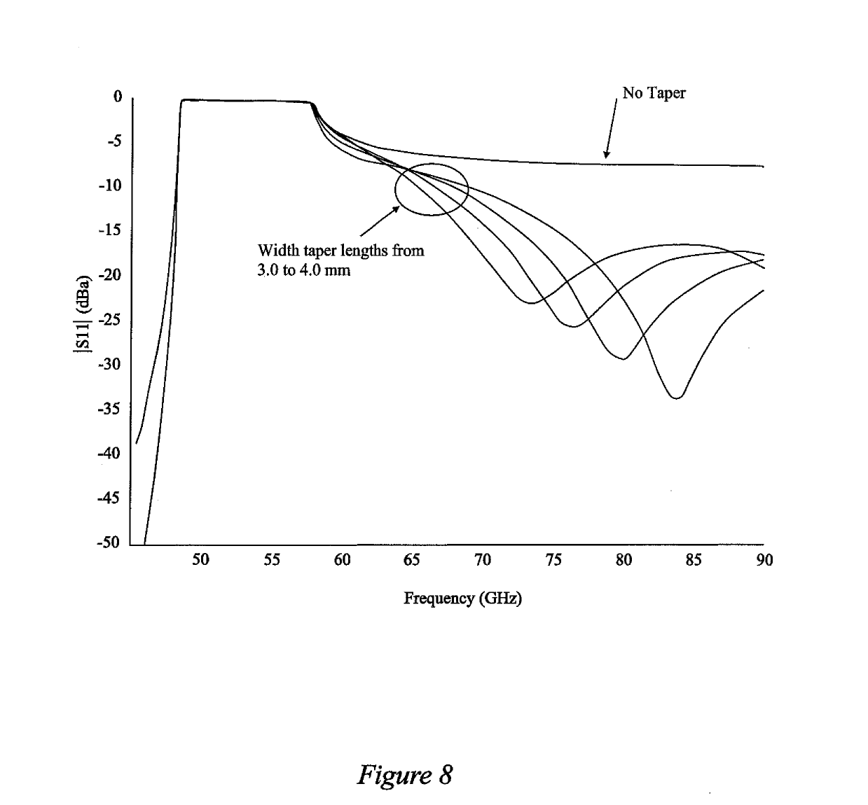

FIG. 8 shows a plot of microwave energy reflected back from the transition for transitions having tapers of various lengths and also no taper.

Shown in FIG. 1 is a known substrate integrated waveguide to air filled waveguide transition 1. The transition 1 comprises a substrate integrated waveguide portion 2. This portion 2 comprises electrically conducting top and bottom layers 3,4. Sandwiched between the two layers 3,4 is a dielectric layer 5. The transition 1 also comprises an air filled waveguide portion 6. This portion 6 comprises top and bottom connectors 7,8 defining an air filled waveguide section 9 therebetween. The dielectric layer 5 ends abruptly at the interface 10 between the substrate integrated waveguide portion 2 and air filled waveguide portion 6. The height of the air filled waveguide section 9 increases in a series of steps in a direction away from the substrate integrated waveguide portion 2 until the height is the same as that of a standard air filled rectangular waveguide.

In use an incident microwave signal passes from the substrate integrated waveguide portion 2 into the air filled waveguide section 9 defined by the top and bottom connectors 7,8. The abrupt end of the dielectric layer results in a significant degree of return loss with a portion of the incident microwave signal being reflected back along the substrate integrated waveguide portion 2.

Shown in FIG. 2 in vertical cross section is a substrate integrated waveguide to air filled waveguide transition 11 according to the invention. The transition 11 comprises an electrically conductive top layer 12 extending along a long axis from a first end 13 to a second end 14 of the transition 11. A width axis is further defined by this layer 12, lying orthogonal to the long axis in the plane of the layer (so extending normal to the page of the figure). The transition 11 further comprises an electrically conductive base layer 15 spaced apart from the top layer 12. The base layer 15 also extends along the long axis from the first end 13 to the second end 14 of the transition 11. The layers 12,15 form a waveguide therebetween. Additional electrically conductive vertical sidewalls may be included to constrain the waveguide in the width direction as would be known to one skilled in the art. For simplicity these are not shown.

Arranged between the top layer 12 and the base layer 15 is a dielectric layer 16. The dielectric layer 16 extends from proximate to the first end 13 to an end point 17 part way to the second end 14 as shown. The dielectric 16 is arranged in a region of constant separation between the top layer 12 and base layer 15 and so is of constant thickness. Beyond the end point 17 the space 18 between the top and bottom layers 12,15 is air filled, forming an air filled waveguide.

The substrate integrated waveguide to air filled waveguide transition 11 comprises a transition region 19 arranged between the end point 17 and second end 14. In the transition region 19 the separation between the top layer 12 and base layer 15 increases. In this particular embodiment it increases in a series of steps, producing an air filled waveguide 18 of increasing cross section in a direction towards the second end 14. In an alternative embodiment the separation smoothly increases.

FIG. 3 shows the substrate integrated waveguide to air filled waveguide transition 11 of FIG. 2 in perspective view. A portion of the top layer 12 not covering the dielectric layer 16 has been removed so the dielectric layer 16 and base layer 15 can be seen. The top layer 12 and dielectric layer 16 each include a plurality of vias 20. The vias 20 are arranged in lines. In use a signal is provided to the portion of the top layer 12 between the lines. As is well known to one skilled in the art only the portion of the top layer between the lines of vias needs to be considered when determining the behaviour of the transition 11. As can be seen, the portion of the dielectric layer 16 between the lines of vias comprises a portion 21 of uniform width. Extending from this portion 21 of uniform width towards the second end is a taper portion 22. The taper portion 22 has a width which tapers to a point at the end point 17. In this embodiment the width of the taper portion 22 decreases uniformly with length towards the end point 17 and has straight sides of equal length. Typically taper portions 22 of transitions according to the invention have mirror symmetry about the length axis passing through the end point 17. In this embodiment the taper portion 22 is an isosceles triangle. The two sides of the taper portion 22 come to a sharp point at the end point 17.

In contrast to the dielectric layer 16 the portion of the top layer 12 adjacent to the dielectric taper portion 22 increases in width from an end proximate to the first end 13 towards the second end 14 as shown.

FIG. 4 shows an alternative embodiment of a substrate integrated waveguide to air filled waveguide transition 11 according to the invention in plan view. In this embodiment the width of the taper portion 22 decreases non-uniformly with length towards the end point 17 as shown. This results in a taper portion 22 having curved sides. Again, the taper portion 22 has mirror symmetry about the long axis passing through the end point 17. In this embodiment the taper portion 22 ends in a rounded end.

In the above embodiments the taper portion 22 has mirror symmetry about the long axis through the end point 17. In alternative embodiments the taper portion 22 lacks this symmetry. For example one side of the taper portion 22 may be straight whilst the other is curved.

Shown in FIG. 5 is a further embodiment of a substrate integrated waveguide to air filled waveguide transition 11 according to the invention in vertical cross section. Connected to the first end 13 is a signal source 24. The signal source 24 is adapted to provide a microwave signal, preferably in the E band range to the transition. The length of the taper portion 22 is substantially equal to the guide wavelength, λg, of the signal provided by the signal source 24. In alternative embodiments the length of the taper portion 22 is in the range of 0.5 λg to 5 λg. More preferably, the length of the taper portion 22 is in the range 0.8 λg to 1.5 λg.

Shown in FIG. 6 in vertical cross section is a device 25 incorporating two of the transitions 11 according to the invention. The device 25 comprises a first transition 11. The second end of the transition 11 is connected to an air filled waveguide 26. Connected to the other end of the air filled waveguide 26 is the second end of a second transition 11. In use a microwave signal travels along the first substrate integrated waveguide to the first transition 11. It exits the first transition 11 and travels along the air filled waveguide 26 to the second transition 11. It then passes through the second transition 11, exiting the second transition 11 along a further substrate integrated waveguide.

Shown in FIG. 7 is a plot of insertion loss against frequency for a transition 11 according to the invention as shown in FIG. 5. The transition 11 includes a taper portion 22 having straight sides of equal length. The length of the taper portion 22 varies between 3 and 4 mm. A plot of insertion loss against frequency for a transition 11 of the same dimensions but lacking a taper portion 22 is also shown for comparison. As can be seen the taper portion 22 significantly reduces insertion loss.

Shown in FIG. 8 is a plot of the amount of microwave energy reflected back from the transition 11 as a function of frequency for the taper portion lengths of FIG. 7. Again, data for a transition 11 of the same dimensions but lacking a taper portion 22 is included for reference. Inclusion of the taper portion 22 significantly reduces the energy reflected back from the transition 11.

1. A substrate integrated waveguide to air filled waveguide transition comprising:
an electrically conductive top layer;
an electrically conductive base layer spaced apart from the top layer, the top and base layers each extending along a length axis from a first end to a second end of the transition, the top layer defining a width axis normal to the length axis in the plane of the top layer, wherein a separation between the top layer and base layer increases towards the second end in a transition region; and
a dielectric layer sandwiched between the top and base layers, the dielectric layer including a taper portion having a width which tapers to a point at an end point between first and second ends, the width of the taper decreasing towards the second end.

2. The substrate integrated waveguide to air filled waveguide transition as claimed in claim 1, wherein the transition region is arranged between the end point and second end.

3. The substrate integrated waveguide to air filled waveguide transition as claimed in claim 1, wherein the top layer is planar.

4. The substrate integrated waveguide to air filled waveguide transition as claimed in claim 1, wherein the separation between the top and base layers in the transition region increases in a series of steps.

5. The substrate integrated waveguide to air filled waveguide transition as claimed in claim 1, wherein the dielectric layer is sandwiched between the top layer and base layer in a region of uniform base layer and top layer separation.

6. The substrate integrated waveguide to air filled waveguide transition as claimed in claim 1, wherein the width of the taper decreases uniformly with length towards the end point.

7. The substrate integrated waveguide to air filled waveguide transition as claimed in claim 1, wherein the width of the taper decreases non-uniformly with length towards the end point.

8. The substrate integrated waveguide to air filled waveguide transition as claimed in claim 1, wherein the tip of the taper is rounded.

9. The substrate integrated waveguide to air filled waveguide transition as claimed in claim 1, wherein the tip of the taper is a sharp point.

10. The substrate integrated waveguide to air filled waveguide transition as claimed in claim 1, wherein the dielectric layer comprises a portion of uniform width, the taper portion extending from the region of uniform width towards the second end.

11. The substrate integrated waveguide to air filled waveguide transition as claimed in claim 1, further comprising an air filled waveguide connected to the second end.

12. The substrate integrated waveguide to air filled waveguide transition as claimed in claim 1, further comprising a substrate integrated waveguide connected to the first end.

13. The substrate integrated waveguide to air filled waveguide transition as claimed in claim 1, further comprising a signal source connected to the transition and adapted to provide an electromagnetic signal thereto.

14. The substrate integrated waveguide to air filled waveguide transition as claimed in claim 13, wherein the length of the taper is in the range 0.5 λg to 5 λg is the guide wavelength of the electromagnetic signal propagating through the transition.

15. The substrate integrated waveguide to air filled waveguide transition as claimed in claim 14, wherein the length of the taper is in the range 0.5 λg to 2 λg.

16. The substrate integrated waveguide to air filled waveguide transition as claimed in claim 1, wherein a portion of at least one of the top layer and base layer adjacent to the taper portion of the dielectric increases in width towards the second end.

17.-18. (canceled)

19. The substrate integrated waveguide to air filled waveguide transition as claimed in claim 11, wherein the air filled waveguide connected to the second end integrally extends from the second end.

20. The substrate integrated waveguide to air filled waveguide transition as claimed in claim 12, wherein the substrate integrated waveguide connected to the first end integrally extends from the first end.

21. The substrate integrated waveguide to air filled waveguide transition as claimed in claim 13, wherein the electromagnetic signal is an E band electromagnetic signal.

22. The substrate integrated waveguide to air filled waveguide transition as claimed in claim 14, wherein the length of the taper is in the range 0.8 λg to 1.5 λg.
